(19) United States
(12) Patent Application Publication
(10) Pub. No.: US 2019/0021323 A1
(43) Pub. Date: Jan. 24, 2019

(54) Use of Gibberellin A5 to Increase the Yield and Quality of Wine Grapes

(71) Applicant: UTI Limited Partnership, Calgary (CA)

(72) Inventors: Federico Javier Berli, Godoy Cruz (AR); Richard Persons Pharis, Calgary (CA); Ambrosio Rubén Bottini, Chacras de Coria (AR); Rodrigo Emanuel Alonso, Luján de Cuyo (AR)

(21) Appl. No.: 16/138,335

(22) Filed: Sep. 21, 2018

Related U.S. Application Data
(63) Continuation of application No. PCT/CA2017/050362, filed on Mar. 22, 2017.
(60) Provisional application No. 62/312,081, filed on Mar. 23, 2016.

(51) Int. Cl. A01N 43/12

(52) U.S. Cl. CPC A01N 43/12

(57) ABSTRACT

A method for increasing the harvest yield of wine grapes per hectare, via increased berry numbers per bunch, while enhancing grape quality. The method comprises applications of a solution comprising one of gibberellins GA5, GA4, or a mixture of GA4 and GA7 (GA4/7) to developing grape berry bunches, at a concentration selected from the range of about 5 mg/L to about 50 mg/L. The solution is preferably applied during a time selected from the range of about 60 days to about 30 days before veraison.

### CROSS REFERENCE TO RELATED APPLICATION

This application is a continuation application of International Application No. PCT/CA2017/050362 filed Mar. 22, 2017 which claims priority to and the benefit of U.S. Provisional Application No. 62/312,081 filed Mar. 23, 2016 and the specification and claims thereof are incorporated herein by reference.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION BY REFERENCE OF MATERIAL SUBMITTED ON A COMPACT DISC

Not Applicable.

### STATEMENT REGARDING PRIOR DISCLOSURES BY THE INVENTOR OR A JOINT INVENTOR

Not Applicable.

### COPYRIGHTED MATERIAL

Not Applicable.

### TECHNICAL FIELD

This disclosure relates to use of plant growth hormones. More specifically, this disclosure pertains to use of compositions comprising gibberellin GA5 or gibberellin GA4 or mixtures of gibberellins GA4 plus GA7 for increasing the yield and quality of grapes.

### BACKGROUND

Gibberellins are one of the six major groups of plant growth hormones and generally comprise a group of tetracyclic diterpenoid compounds. The skeleton below shows the carbon numbering of the C₁₉ class of gibberellins:

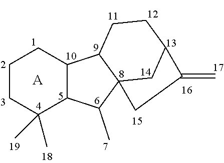

There are over 130 known gibberellins and many occur naturally in plants. Individual gibberellins are designated with an integer that reflects their chronological order of discovery. Four examples of gibberellins that occur naturally in higher plants are shown below are gibberellins A₃, A₄, A₅, A₇, and are commonly referred to as GA₃, GA₄, GA₅, GA₇ or alternatively as GA3, GA4, GA5, GA7.

Exogenous applications of gibberellins are known to stimulate shoot growth, stem growth, flowering, and growth expansion of fruits and berries, among other effects. Consequently, three gibberellins have been used extensively for commercial purposes, i.e., GA₃ (also known as gibberellic acid) and mixtures of GA₄ and GA₇ (commonly referred to as GA_{4/7}). GA3 has been used extensively for improving the appearance and quality of table grapes. For example, exogenous applications of GA3 to Thompson seedless table grape vines about three weeks before bloom have been shown reduce fruit set and also reduce berry cluster compactness. This results in increased size and elongation of the Thompson seedless table grape berries and fruit clusters. Typical GA3 application rates for grape crops comprise a solution containing 1 mg/L to 10 mg/L applied at a volume of about 100 gal/ac (i.e., about 1123.4 L/ha). However, GA3 is not widely used on wine grapes because of the risk for significant development of “shot berries” (i.e., small undeveloped berries). There are also potential reductions in “return bloom” i.e., a reduced number of flowering shoots during the production season following the season during which GA3 was applied.

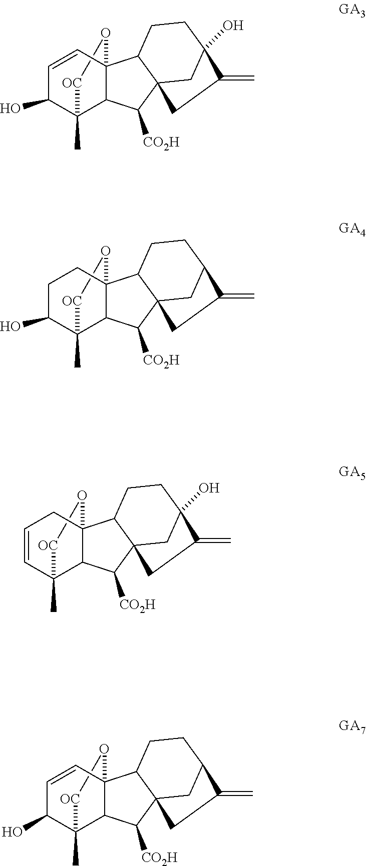

Another problem associated with use of GA3 to increase the grape berry size is that colour development may be suppressed, indicating that the development of anthocyanins and polyphenols may be impaired. If this were to occur, the quality of GA3-treated grapes, both wine and table grapes would be negatively affected.

### SUMMARY

The embodiments of the present disclosure pertain to methods for improving the yield and quality of wine and table grapes wherein the methods comprise a step of applying a solution comprising at least one of GA5, GA4, and a mixture of GA4 and GA7 (GA4/7).

According to one aspect, the solution comprises a concentration of GA5 or GA4 or GA4/7 selected from the range of about 10 mg/L to about 50 mg/L.

According to another aspect, the solution is applied at a time selected from the range of about 60 days to about 30 days before veraison. It is within the scope of the present disclosure for the methods to comprise a first application of the solution to be made at about 60 days before veraison, and a second application of the solution to be made at about 30 days before veraison.

### BRIEF DESCRIPTION OF THE FIGURES

The present disclosure will be described in conjunction with reference to the following drawings in which:

FIGS. 1A-1C are charts showing the effects, in the first experimental trial (2010-2011) of GA5 applied by bunch dip at all of 35, 21 and 0 days before veraison (DBV) on shoot length (FIG. 1A), numbers of leaves per shoot (FIG. 1B), and the leaf surface area per shoot (FIG. 1C) of cv. Malbec grapes. Values are a mean (n=5) of the difference between the measurement taken before GA5 application and that taken at harvest. Error bars are +/−1 SEM;

FIG. 2A is a chart showing the effects of GA5 applied by bunch dip at each of 35, 21 and 0 days before veraison (DBV) on the average per bunch fresh weight of grape berries, in the first experimental trial (2010-2011). FIG. 2B is a chart showing the effects of the GA5 on the average number of grape berries per bunch during the first experimental trial, while FIG. 2C) is a chart showing the effects of GA5 on return bloom i.e., the numbers of fruit bunches per shoot in GA5-treated cv. Malbec grapes produced during the following season. Values are a mean (n=5) of the difference between the measurement taken before GA5 application and that taken at harvest. Error bars are +/−1 SEM;

FIG. 3A is a chart showing the effects, in the second trial (2012-2013) of GA5 applied by bunch dip once at 30 days before veraison (DBV) on shoot length, while FIG. 3B is a chart showing the effects of the GA5 on the leaf surface area per shoot of cv. Malbec grapes. Values are a mean (n=5) of the difference between the measurement taken before GA5 application and that taken at harvest. Error bars are +/−1 SEM;

FIG. 4A is a chart showing the effects, in the second trial (2012-2013) of GA5 applied by bunch dip once at 30 days before veraison (DBV) on the average per bunch fresh weight of grape berries, while FIG. 4B is a chart showing the effects of GA5 on the numbers of grape berries per bunch of cv. Malbec grapes. Values are a mean (n=5) of the difference between the measurement taken before GA5 application and that taken at harvest. Error bars are +/−1 SEM;

FIGS. 5A-5C are charts showing the effects in the third experimental trial (2014-2015) of GA5 applied by each of a single bunch dip or bunch spray at 60 days or 30 days before veraison (DBV) on the average per bunch fresh weight of grape berries (FIG. 5A), the number of grape berries per bunch (FIG. 5B), and the average per berry fresh weight (FIG. 5C) of harvested cv. Malbec grapes. Values are a mean (n=5) of the difference between the measurement taken before GA5 application and that taken at harvest. Error bars are +/−1 SEM;

FIGS. 6A-6C are charts showing the effects (2014-2015) of GA5 applied by each of a single bunch dip or bunch spray at 60 days or 30 days before veraison (DBV) on the average per berry dry weight (FIG. 6A), the average per berry water content (FIG. 6B), and the °Brix of the grape juice (FIG. 6C) of harvested cv. Malbec grapes. Values are a mean (n=5). Error bars are +/−1 SEM;

FIGS. 7A-7C are charts showing the effects in the third experimental trial (2014-2015) of GA5 applied by each of a single bunch dip or spray at 60 days or 30 days before veraison (DBV) on the average sugar content per berry (FIG. 7A), the average anthocyanin content per berry skin (FIG. 7B), and the total polyphenol index (TPI) per berry skin (FIG. 7C) of harvested cv. Malbec grapes. Values are a mean (n=5). Error bars are +/−1 SEM;

FIGS. 8A-8C are charts showing the effects in the third experimental trial (2014-2015) of GA4 applied by each of a single bunch dip or bunch spray at 60 days or 30 days before veraison (DBV) on the average per bunch fresh weight of grape berries (FIG. 8A), the number of berries per bunch (FIG. 8B), and the average fresh weight per berry (FIG. 8C) of harvested cv. Malbec grapes. Values are a mean (n=5) of the difference between the measurement taken before GA4 application and that taken at harvest. Error bars are +/−1 SEM;

FIGS. 9A-9C are charts showing the effects in the third experimental trial (2014-2015) of GA4 applied by each of a single bunch dip or spray at 60 days or 30 days before veraison (DBV) on the average per berry dry weight (FIG. 9A), the average per berry water content (FIG. 9B), and the °Brix of the grape juice (FIG. 9C) of harvested cv. Malbec grapes. Values are a mean (n=5). Error bars are +/−1 SEM;

FIGS. 10A-10C are charts showing the effects in the third experimental trial (2014-2015) of GA4 applied by each of a single bunch dip or spray at 60 days or 30 days before veraison (DBV) on the average sugar content per berry (FIG. 10A), the average anthocyanin content per berry skin (FIG. 10B), and the total polyphenol index (TPI) per berry skin (FIG. 10C) of harvested cv. Malbec grapes. Values are a mean (n=5). Error bars are +/−1 SEM;

FIGS. 11A-11C are charts showing the effects in the third experimental trial (2014-2015) of a GA4-rich mixture of GA4+GA7 (GA4/7) applied by each of a single bunch dip or spray at 60 days or 30 days before veraison (DBV) on the average per bunch fresh weight of grape berries (FIG. 11A), the number of berries per bunch (FIG. 11B), and the average fresh weight per berry (FIG. 11C) of harvested cv. Malbec grapes. Values are a mean (n=5) of the difference between the measurement taken before GA4/7 application and that taken at harvest. Error bars are +/−1 SEM;

FIGS. 12A-12C are charts showing the effects in the third experimental trial (2014-2015) of a GA4-rich mixture of GA4+GA7 (GA4/7) applied by each of a single bunch dip or spray at 60 days or 30 days before veraison (DBV) on the average per berry dry weight (FIG. 12A), the average water content per berry (FIG. 12B), and the °Brix of the grape juice (FIG. 12C) of harvested cv. Malbec grapes. Values are a mean (n=5). Error bars are +/−1 SEM; and

FIGS. 13A-13C are charts showing the effects in the third experimental trial (2014-2015) of a GA4-rich mixture of GA4+GA7 (GA4/7) applied by each of a single bunch dip or spray at 60 days or 30 days before veraison (DBV) on the average sugar content per berry (FIG. 13A), the average anthocyanin content per berry skin (FIG. 13B), and the total polyphenol index (TPI) per berry skin (FIG. 13C) of harvested cv. Malbec grapes. Values are a mean (n=5). Error bars are +/−1 SEM.

### DETAILED DESCRIPTION

The embodiments of the present disclosure generally pertain to methods for increasing the yields and quality of wine and table grapes by applications of each of the gibberellins, GA5, GA4, and a GA4-rich mixture of GA4 and GA7 (GA4/7) during the early stages, i.e. 60 to ca. 30 days before veraison (DBV) of grape bunch and grape berry development during the growing season.

While it is well-known that exogenous applications of the gibberellin GA3 can enhance the berry and bunch size, and visual appearance of table grapes, exogenous GA3 applications are not commonly used during commercial production of wine grapes because the stimulation of shoot and leaf growth divert the treated plants' energy and nutrients from the development of the berry bunches thereby reducing the grape yields. Other problems associated with the use of GA3 on wine grapes include a tendency to initiate and/or increase the occurrence of millanderage in which the grape bunches contain berries that differ greatly in size and maturity at harvest. Very small and underripe grape berries are commonly referred to as “shot” berries. Excessive amounts of shot berries and underripe berries in harvested grapes used for wine production will increase the acidity of the fermenting grape juice and thereby will result in the development of undesirable flavors and aromas which reduce the quality of the wine. Additionally, the following year's return bloom (flowering) can be detrimentally affected in grapes by the use of GA3 which has long-lasting effects.

However, we have surprisingly discovered that exogenous applications of GA5 increase the numbers of final berries produced by grapes thereby significantly increasing the average fresh weight per bunch produced by a selected grape variety. GA5 is notably effective in accomplishing this increased bunch harvest weight per shoot and per plant. Concurrently, exogenous applications of GA5 may significantly reduce vegetative shoot growth and leaf area development. Consequently, exogenous applications of GA5 may increase the yields of grapes on a per hectare basis. Furthermore, GA5 does not cause increases in the occurrence of shot berries or in the frequencies of shot berry occurrence. Grape berries harvested from grapevines receiving exogenous applications of GA5 also have higher sugar contents, higher total polyphenol contents, and higher anthocyanin pigment contents, thereby increasing the quality of the berries from vines that receive exogenous GA5 applications. We have observed similar benefits from exogenous applications of GA4 and mixtures of GA4 and GA7 (also referred to herein as GA4/7 mixtures). It should be noted that a GA4 rich GA4/7 mixture may have a GA4/7 ratio selected from a range of 1.5:1, 2:1, 2.5:1. 3:1, 4:1, 5:1, 6:1, 7:1, 10:1, 15:1, and therebetween.

Accordingly, an embodiment of the present disclosure pertains to methods of increasing the “per bunch”, “per plant” and “per hectare” harvest yields, while maintaining or increasing the quality of the grapes by exogenous applications of specific gibberellins. These increased harvest yields are due mainly to significant increases in per bunch berry numbers (via reduced berry drop/berry abortion). The increased harvest yields are gained by exogenous applications of GA5 or of GA4 or of GA4/7 mixtures to grapevines bearing developing berry bunches, during a period of time ranging from about 60 days before veraison (DBV) i.e. 57 to 63 DBV to about 30 DBV i.e., 28 to 32 DBV. The term “veraison” represents the time when grape berries begin to show the first signs of ripening and skin colour development (which in red varieties is caused by increasing concentrations of anthocyanins in the grape skins). Veraison also refers to the time when berry development transitions from berry growth (i.e. rapid increases in the size and volume of the berries) to berry ripening which is characterized by the accumulation of sugars and in red grapes, especially, phenolic compounds.

According to one aspect, the methods include one application of a solution comprising 5 mg/L to 50 mg/L of GA5, at a time selected between about 60 DBV and about 30 DBV. The GA5 solution may additionally comprise a surfactant for example, between 0.05% v/v to 2.5% v/v. The GA5 is preferably dissolved in (or formulated with) an alcohol(s) prior to dilution to the final application volume. According to one aspect the exogenously applied GA5 solution may be applied by bunch line spraying of the grape berry bunches, by submerging the berry bunches into the GA5 solution, by brushing the GA5 solution onto the berry bunches. According to another aspect, the methods may include several applications of exogenous GA5 solutions to grapevines bearing developing berry bunches, wherein the first application is made about 60 DBV and the additional application(s) is made prior to, or near 30 DBV.

Another exemplary embodiment of the present disclosure pertains to methods of increasing the yields and quality of wine grapes by exogenous applications of GA4 or alternatively GA4/7 mixtures, to grapevines bearing developing berry bunches, during a period of time ranging between about 60 DBV to about 30 DBV. According to one aspect, the methods include one application of a solution comprising 5 mg/L to 50 mg/of GA4 or alternatively, 5 mg/L to 50 mg/of a GA4-rich GA4/7 mixture, at a time selected between about 60 DBV and about 30 DBV. The solution may additional comprise a surfactant for example, between 0.05% v/v to 2.5% v/v. The GA4 or alternatively a GA4-rich GA4/7 mixture, is preferably dissolved in (or formulated with) an alcohol(s) prior to dilution to the final application volume. According to one aspect, the exogenously applied GA4 or a GA4-rich GA4/7 mixture may be applied by bunch line spraying of the grape berry bunches. According to another aspect, the exogenous GA4 solution or alternatively a GA4-rich GA4/7 solution, may be applied by spraying of the berry bunches, or by submerging the berry bunches into the solution, or by brushing the solution onto the berry bunches. According to another aspect, the methods may include several applications of spaced-apart exogenous GA4 solutions or GA4-rich GA4/7 solutions to grapevines bearing developing berry bunches, wherein the first application is made about 60 DBV and the second application is made prior to or about 30 DBV.

Another method of the present disclosure pertains to methods of increasing the yields and quality of wine grapes by two exogenous applications of the specified gibberellins to grapevines bearing developing berry bunches during a period of time ranging between about 60 DBV to about 30 DBV wherein the first application is made about 60 DBV with a solution comprising 5 mg/L to 50 mg/L of GA5 and the second application is made about 30 DBV with a solution comprising 5 mg/L to 50 mg/L of GA4 or alternatively, 5 mg/L to 50 mg/L of a GA4-rich GA4/7 mixture. Alternatively the first application at about 60 DBV may be made with a solution comprising 5 mg/L to 50 mg/L of GA4 or alternatively, 5 mg/L to 50 mg/L of a GA4-rich GA4/7 mixture while the additional applications are made about 30 DBV with a solution comprising 5 mg/L to 50 mg/L of GA5.

It is within the scope of the present disclosure for the gibberellins solutions to comprise GA5, GA4, or GA4/7 mixtures in the form of free acids or as salts or as esters thereof. Suitable salts and esters include the sodium salts and potassium salts and the C₁₋₄ (C₁₋₄) carboxyl acid esters.

### EXAMPLES

### Example 1: Effects of GA5 Compositions on Berry and Bunch Production by cv. Malbec Grapes (2010-2011)

Grapevines were selected from a clone of Vitis vinifera L. cv. Malbec, planted in 1997 on their own roots in a commercial vineyard located in Gualtallary, Mendoza, Argentina (1450 m above sea level, 69°15′37″ W and 33°23′51″ S). The vines were trained on a vertical trellis system arranged in north-south oriented rows spaced 2 m apart, with 1.20 m between plants within the row. The grapevines were maintained with no soil water restriction during the whole experiment by the use of a drip irrigation system (4 liters per plant per night), and the fruiting vines were protected with anti-hail nets (black polyethylene).

Three concentrations of GA5 (5 mg/L, 50 mg/L, 250 mg/L) were compared to controls which did not receive any growth regulator treatments. The treatments were applied by submerging all of the fruit bunches on each vine in a treatment group in the selected aqueous solution (fruit bunches from control vines were submerged in water). All of the treatment solutions, including the water controls, contained 0.1% v/v of the surfactant TRITON®-X (TRITON is a registered trademark of the Dow Chemical Co., Indianapolis, Ind., USA) and a minimal amount of 95% EtOH to dissolve the GA5 powders (the control treatments also included a minimal amount of 95% EtOH). The treatments were applied three times; 56 days after flowering (DAF; i.e., 35 days before veraison—“DBV”), 70 DAF (i.e., 21 DBV), and 91 DAF (i.e., 0 DBV). The 91 DAF treatment time corresponded to veraison. Each berry bunch on a test vine was submerged in 750 mL of the selected treatment solution for 15 sec during a late afternoon time period.

A randomized complete block design with 4 treatments and 5 blocks was used during the 2010-2011 production season. The experimental unit consisted of one plant selected as being “typical” among 6 consecutive plants in a selected row. Each row was a replicate, i.e., a “block”. There were thus 5 experimental units (plants) utilized for each treatment, one for each row (block). All the grapevines in the 5 replicate rows were pruned to 8 “fruiting” shoots and the crop load on each shoot was thinned to two bunches per shoot at 40 days after flowering (DAF). One shoot per experimental unit was selected, marked and used for the non-destructive measurements (shoot length, number of leaves and leaf area), while the rest of the shoots were used for berry sampling.

### Vegetative Growth Measurements

Shoot length, number of leaves and midrib (main vein) length of all leaves were measured at: (i) 56 DAF/35 DBV just before application of the first set of treatments, and (ii) 132 DAF (harvest date). At the 132 DAF, all of the leaves from 10 randomly selected shoots were collected in nylon bags, kept on ice to prevent dehydration, and were taken to the laboratory where the length of the leaf midribs, weights of separated leaves, and the weights of 1-cm² leaf discs were determined. Then, the leaf areas (LA) were calculated and, based on the weights, a linear regression model between the LA and the midrib length was generated. The correlation coefficient (r²) was 0.91 and thus the model was used to transform the non-destructive measurements of midrib length into LA values.

### Number and Weight of Grape Bunches and Berries

At 132 DAF, the two selected and marked bunches from one fruiting shoot per experimental unit, i.e. not used for berry sampling, were collected in nylon bags and weighed. Then the number of berries per bunch was counted.

Finally, in the next year's flowering and fruiting season (early 2012) the number of fruit clusters bunches per shoot were counted in order to assess GA5 treatment effects on return bloom.

### Results

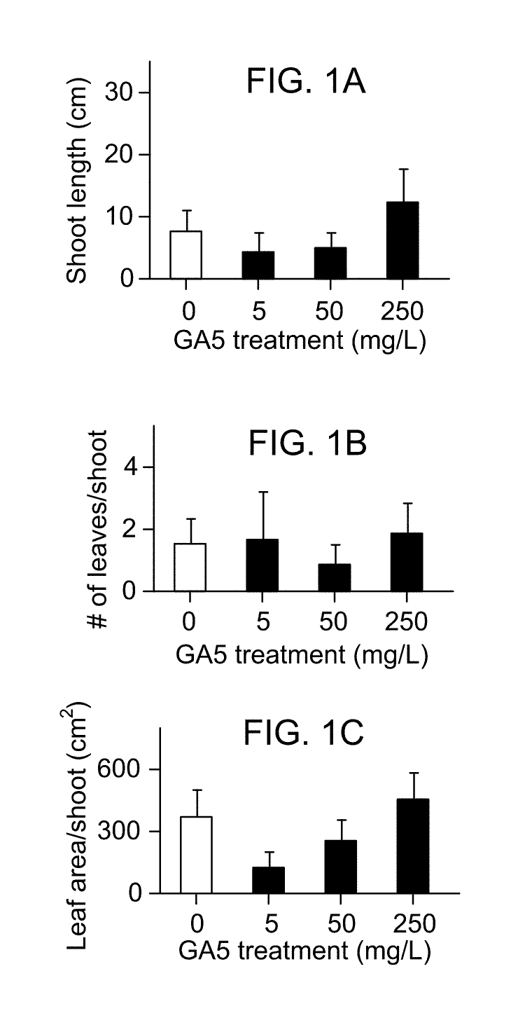

Vegetative growth of the cv. Malbec grapevine shoots during the later stages of production, i.e., post-56 DAF (FIGS. 1A-1C) was not significantly affected by any of the GA5 treatments in comparison to the controls, indicating that GA5 did not have the same stimulatory effects on increasing shoot lengths and number of leaves as typically seen with GA3 applications. The lower GA5 concentrations (i.e., 5 mg/L, 50 mg/L) tended to reduce the leaf surface area (FIG. 1C). It should be noted that the GA5 treatments were applied by submerging the developing berry bunches, and it is likely that spray applications of the GA5 treatments, as would be done during commercial production, would have magnified the reduction of leaf growth and development.

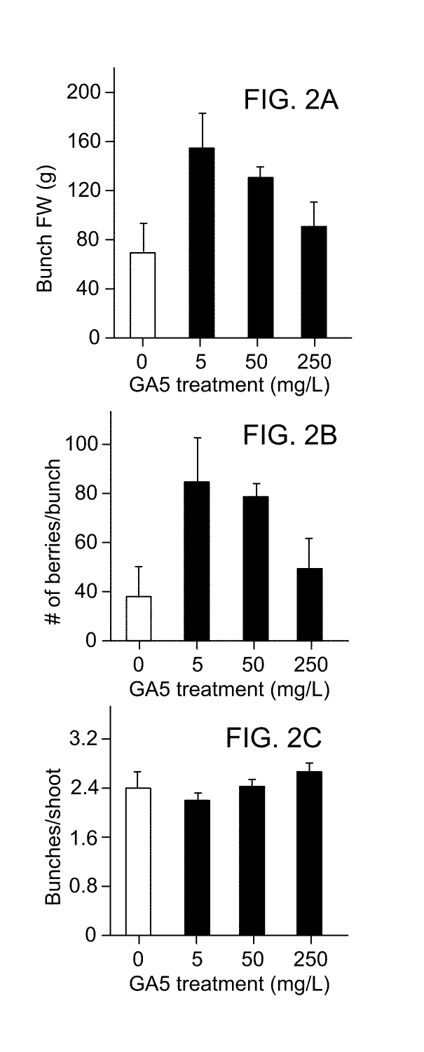

Submerging the fruit bunches into solutions comprising the lower GA5 application rates at all of 56 DAF, 70 DAF, and 91 DAF resulted in significant increases in the per bunch fresh weights of grape berry bunches harvested at 132 DAF (FIG. 2A), and in especially in the numbers of berries produced per bunch (FIG. 2B).

We noted that there were no significant effects on the numbers of fruit clusters (bunch numbers) that developed on the shoots of the test plants during the following season (assessed in early 2012 (FIG. 2C).

### Example 2: Effects of GA5 Compositions on Berry and Bunch Production by cv. Malbec Grapes (2012-2013)

A second trial was done in the same vineyard used for the trial outlined in Example 1. Grapevines were selected from a clone of Vitis vinifera L. cv. Malbec, planted in 1997 on their own roots in a commercial vineyard located in Gualtallary, Mendoza, Argentina (1450 m above sea level, 69°15′37″ W and 33°23′51″ S). The vines were trained on a vertical trellis system arranged in north-south oriented rows spaced 2 m apart, with 1.20 m between plants within the row. The grapevines were maintained with no soil water restriction during the whole experiment by the use of a drip irrigation system (4 liters per plant per night), and the fruiting vines were protected with anti-hail nets (black polyethylene).

Four concentrations of GA5 i.e., 5 mg/L, 20 mg/L, 50 mg/L, 250 mg/L, were compared to controls which did not receive any growth regulator treatments. The treatments were applied by submerging all of the fruit bunches on each vine in a treatment group in the selected aqueous solution (fruit bunches from control vines were submerged in water). All of the treatment solutions, including the water controls, contained 0.1% v/v of the surfactant TRITON®-X and a minimal amount of 95% EtOH to dissolve the GA5 powders (the control treatments also included a minimal amount of 95% EtOH). All treatments were applied once at 30 DBV (i.e. 61 DAF). Each berry bunch on a test vine was submerged in 750 mL of the selected treatment solution for 15 sec during a late afternoon time period.

A randomized complete block design with 5 treatments and 5 blocks was used during the 2012-2013 production season. The experimental unit consisted of one plant selected as being “typical” among 6 consecutive plants in a selected row. Each row was a replicate, i.e., a “block”. There were thus 5 experimental units (plants) utilized for each treatment, one for each row (block). All the grapevines in the 5 replicate rows were pruned to 8 “fruiting” shoots and the crop load on each shoot was thinned to two bunches per shoot at 40 days after flowering (DAF). One shoot per experimental unit was selected, marked and used for the non-destructive measurements (shoot length, number of leaves and leaf area), while the rest of the shoots were used for berry sampling.

### Vegetative Growth Measurements

Shoot length, number of leaves and midrib (main vein) length of all leaves were measured at: (i) 30 DBV just before application of the first set of treatments, and (ii) at harvest. At harvest, all of the leaves from 10 randomly selected shoots were collected in nylon bags, kept on ice to prevent dehydration, and were taken to the laboratory where the length of the leaf midribs, weights of separated leaves, and the weights of 1-cm² leaf discs were determined. Then, the leaf areas (LA) were calculated and, based on the weights, a linear regression model between the LA and the midrib length was generated. The correlation coefficient (r²) was 0.91 and thus the model was used to transform the non-destructive measurements of midrib length into LA values.

### Number and Weight of Bunches and Berries

At harvest, the two selected and marked bunches from one fruiting shoot per experimental unit, i.e. not used for berry sampling, were collected in nylon bags and weighed. Then the number of berries per bunch was counted.

### Results

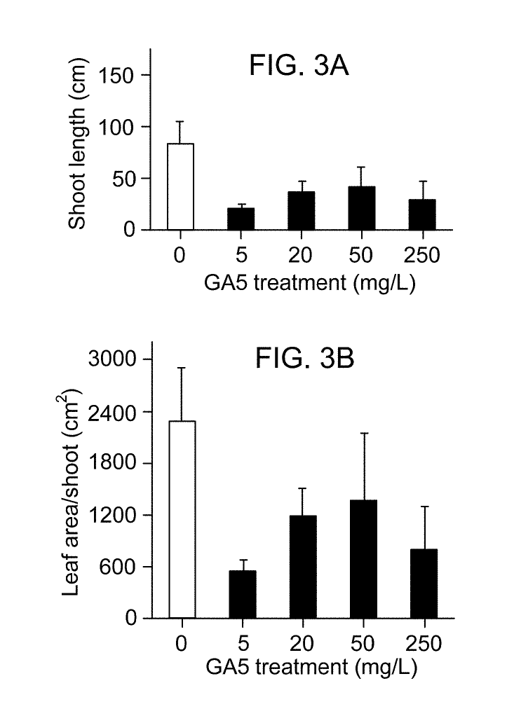

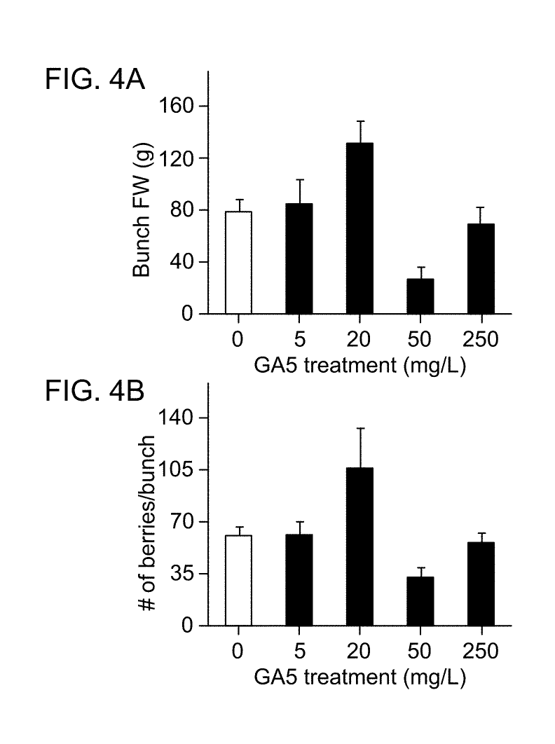

All four GA5 treatments applied at 30 DBV resulted in decreased shoot length, with the 5 mg/L rate being statistically significantly different from the Control (FIG. 3A) and leaf surface area per shoot (FIG. 3B) at harvest time. The 20 mg/L GA5 treatment resulted in significantly increased per bunch fresh weights (FIG. 4A) and also in the numbers of berries per bunch (FIG. 4B). Thus, grape yield per plant and per hectare would have been appreciably increased for the 20 mg/L GA5 application rate.

### Example 3: Effects of (i) GA5 Compositions, (ii) GA4 Compositions, and (iii) GA4-Rich GA4/7 Compositions on Berry and Bunch Production by cv. Malbec Grapes (2014-2015)

A third trial was done in the same vineyard used for the trials outlined in Examples 1 and 2. Grapevines were selected from a clone of Vitis vinifera L. cv. Malbec, planted in 1997 on their own roots in a commercial vineyard located in Gualtallary, Mendoza, Argentina (1450 m above sea level, 69°15′37″ W and 33°23′51″ S). The vines were trained on a vertical trellis system arranged in north-south oriented rows spaced 2 m apart, with 1.20 m between plants within the row. The grapevines were maintained with no soil water restriction during the whole experiment by the use of a drip irrigation system (4 liters per plant per night), and the fruiting vines were protected with anti-hail nets (black polyethylene).

The effects of two concentrations (i.e., 10 mg/L and 50 mg/L) of three different gibberellin compositions (GA5, GA4, and a mixture of GA4 and GA7 referred to as “GA4/7”) on berry and bunch development and quality in treated cv. Malbec vines were compared to control plants which did not receive any growth regulator treatments but were treated with “control water” at the time the growth regulator treatments were applied. All of the treatment solutions, including the water controls, contained 0.1% v/v of the surfactant TRITON®-X and a minimal amount of 96% EtOH to dissolve the various GA5, GA4, and GA4/7 powders (the control treatments also included a minimal amount of 96% EtOH).

The effects of GA applications were assessed at two stages of berry development. The first group of test plants was treated at 60 DBV (i.e. 31 DAF) while a second group of test plants was treated at 30 DBV (i.e. 61 DAF). At each application stage, the groups of test plants receiving selected treatments were each divided into two subsets. The developing berry bunches on the first subset of plants for a selected treatment were treated by submerging into a 750-mL volume of the test solution for a period of 15 sec during late afternoon. The second subset of plants was treated with a spray application of 150 mL of test solution per each test plant. The spray applications were made in late afternoon.

For each of the two application stages, a randomized complete block design with 14 treatments and 5 blocks was used for a total of 25 treatments. The treatments are listed in Table 1. The experimental unit consisted of one plant selected as being “typical” among 6 consecutive plants in a selected row. Each row was a replicate, i.e., a “block”. There were thus 40 experimental units (plants) utilized for each growth regulator. All the grapevines in the 5 replicate rows were pruned to 8 “fruiting” shoots and the crop load on each shoot was thinned to two bunches per shoot at the beginning of the experiment (31 DAF or 60 DBV). One shoot per experimental unit was selected, marked and used for the non-destructive measurements (shoot length, number of leaves and leaf area), while the rest of the shoots were used for berry sampling.

### Number and Weight of Bunches and Weight and Number of Berries

At harvest, the two selected and marked bunches from one fruiting shoot per experimental unit, i.e. not used for berry sampling, were collected in nylon bags and weighed. Then the number of berries per bunch was counted.

TABLE 1

| | | [Conc] | | DBV |
|---|---|---|---|---|
| Trt # | GA | Mg/L | Route | stage |
| 1 | GA5 | 10 | Submerged | 60 |
| 2 | GA5 | 10 | Sprayed | 60 |
| 3 | GA5 | 50 | Submerged | 60 |
| 4 | GA5 | 50 | Sprayed | 60 |
| 5 | GA4 | 10 | Submerged | 60 |
| 6 | GA4 | 10 | Sprayed | 60 |
| 7 | GA4 | 50 | Submerged | 60 |
| 8 | GA4 | 50 | Sprayed | 60 |
| 9 | GA4/7 | 10 | Submerged | 60 |
| 10 | GA4/7 | 10 | Sprayed | 60 |
| 11 | GA4/7 | 50 | Submerged | 60 |
| 12 | GA4/7 | 50 | Sprayed | 60 |
| 13 | Control | 0 | Submerged | 60 |
| 14 | Control | 0 | Sprayed | 60 |
| 15 | GA5 | 10 | Submerged | 30 |
| 16 | GA5 | 10 | Sprayed | 30 |
| 17 | GA5 | 50 | Submerged | 30 |
| 19 | GA5 | 50 | Sprayed | 30 |
| 19 | GA4 | 10 | Submerged | 30 |
| 20 | GA4 | 10 | Sprayed | 30 |
| 21 | GA4 | 50 | Submerged | 30 |
| 22 | GA4 | 50 | Sprayed | 30 |
| 23 | GA4/7 | 10 | Submerged | 30 |
| 24 | GA4/7 | 10 | Sprayed | 30 |
| 25 | GA4/7 | 50 | Submerged | 30 |
| 26 | GA4/7 | 50 | Sprayed | 30 |
| 27 | Control | 0 | Submerged | 30 |
| 28 | Control | 0 | Sprayed | 30 |

### Berry Sampling and Determinations of Weight, Water and Sugars Content

Samples of 25 berries per experimental unit were randomly collected in nylon bags (5 berries from each bunch; two top berries, two middle berries, one bottom berry; for each test vine, berries were collected from 5 bunches exposed to the west). These berry samples were taken at 132 DAF (132 DAF being the time of ripe berry harvest). The berries were kept on dry ice to prevent enzyme activity and dehydration and were taken quickly to the laboratory where berry fresh weights (FW) were determined before the berries were stored at −20° C. Then, 15 berries per experimental unit were defrosted at ambient room temperature after which, the skins were separated from fruit pulp and seeds by hand. The fruit pulp was collected in nylon bags, crushed by hand pressing and the relative concentration of sugars (°Brix) was measured in the pulp juice with a PAL-1 digital hand-held refractometer (Atago Co., Ltd., Tokyo, Japan). The °Brix was multiplied by the berries' FW to calculate sugar on a per berry basis (absolute amounts). The separated skins were extracted with 15 mL of an aqueous ethanolic solution (12% ethanol, 6 g/L tartaric acid and pH 3.2) at 70° C. for 3 h in darkness. Then, the liquid fraction was separated by decanting, maintained for 24 h at 4° C., and then centrifuged 10 min at 10,000 g to eliminate tartrates and other sediments. Finally, the supernatant was collected, frozen and stored at −20° C. Five berries per experimental unit were defrosted at room temperature and used to determine dry weight (DW) of the skins, pulps and seeds, i.e. dried at 40° C. to a constant weight.

### Berry Skin Anthocyanin and Total Polyphenol Content

Ultraviolet-visible spectrophotometric (UV-vis) determinations were performed on the berry skin extraction solution according to a method previously described by Berli et al. (2008, Phenolic composition in grape (Vitis vinifera L. cv. Malbec) ripened with different solar UV-B radiation levels by capillary zone electrophoresis. J. Agr. Food Chem. 56:2892-2898) using a CARY® 50 spectrophotometer (Varian Inc., Palo Alto, Calif., USA) (CARY is a registered trademark of Agilent Technologies Inc., Santa Clara, Calif., USA). For anthocyanin content, the extraction solutions were defrosted, diluted 1:50 with acidified twice-distilled water (1% HCl), and the absorbance was measured at 520 nm against a reagent blank, with a 10 mm optical path cell. For total polyphenol index, the defrosted extraction solutions were diluted 1:100 with twice-distilled water (pH 7.0), and the absorbance measured at 280 nm against a blank of reagents, with a 10 mm optical path cell. The anthocyanin content and total polyphenols index (TPI) were calculated in absolute content (per berry skin) and also per 100 g berry FW.

### Results

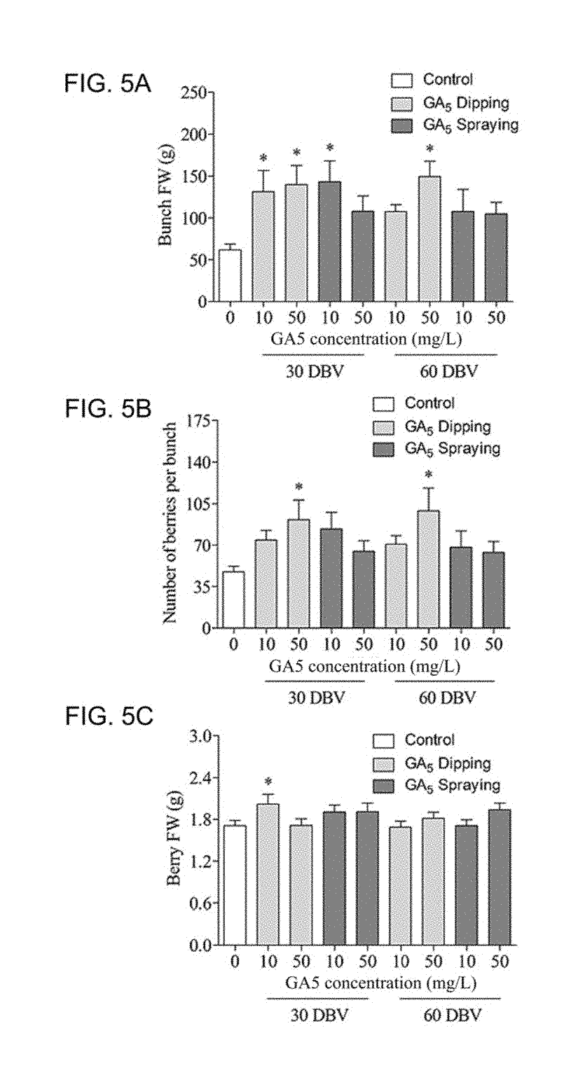

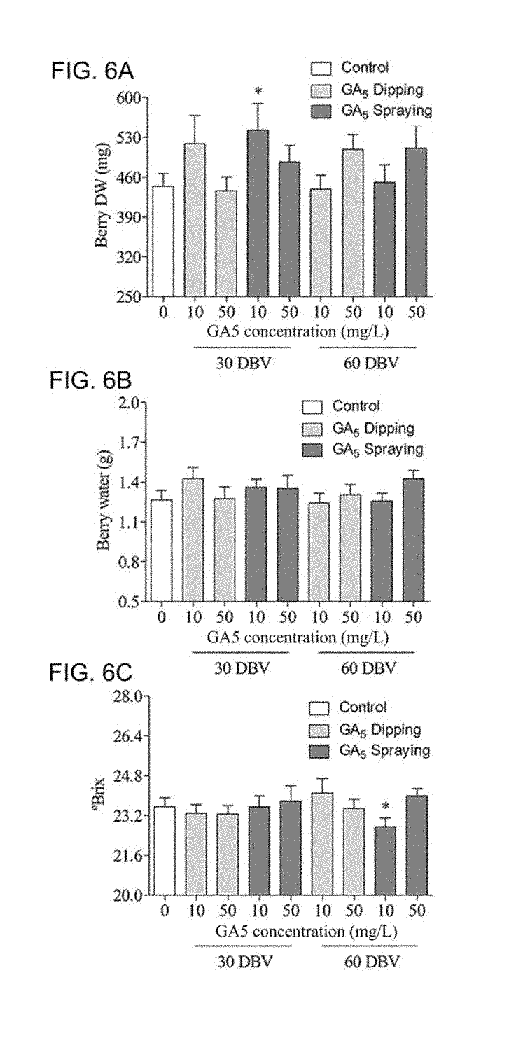

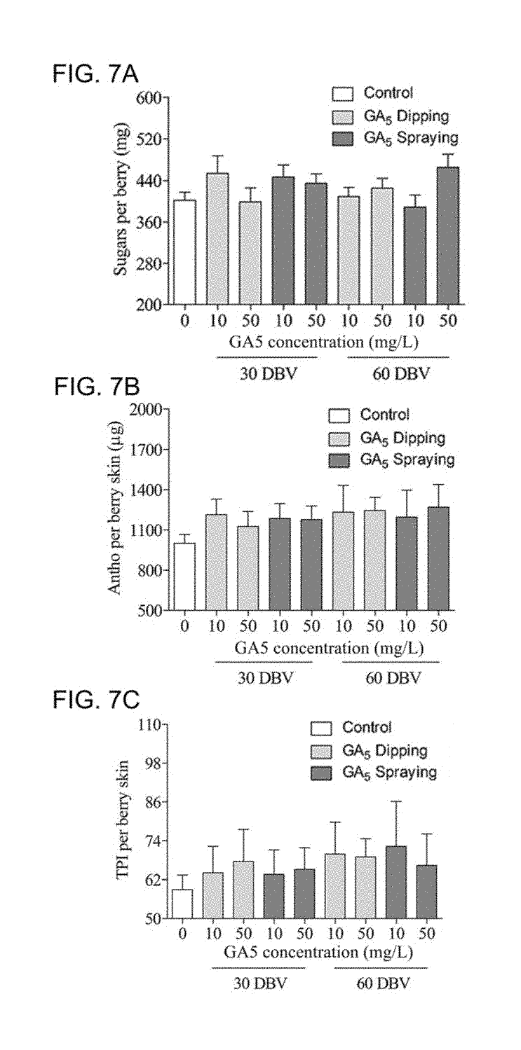

Both rates of GA5 applications (10 mg/L, 50 mg/L), methods of application i.e., submersion and spraying at 60 DBV and at 30 DBV increased the average per bunch fresh weight and numbers of berries formed per bunch (FIGS. 5A, 5B). Fresh weights and dry weights per individual berry were also generally increased (FIGS. 5C, 6A, respectively). While the weights of water and the °Brix were similar to the controls (FIGS. 6B, 6C), both GA5 concentrations and both application methods resulted in (non-significant) increased sugar levels in the berries (FIG. 7A). Anthocyanin concentrations and the total polyphenol index (TPI) in the grape skins also tended to be generally increased, relative to controls (FIGS. 7B, 7C).

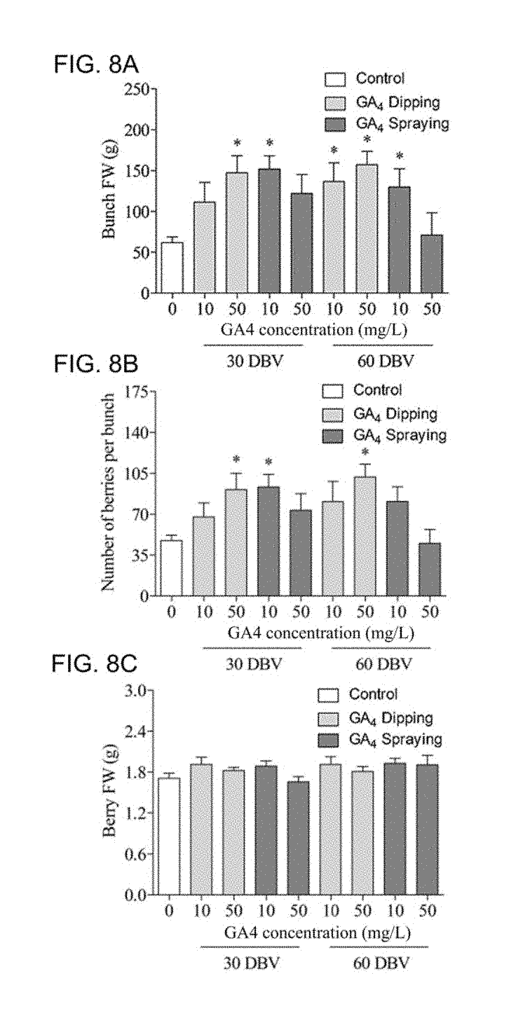

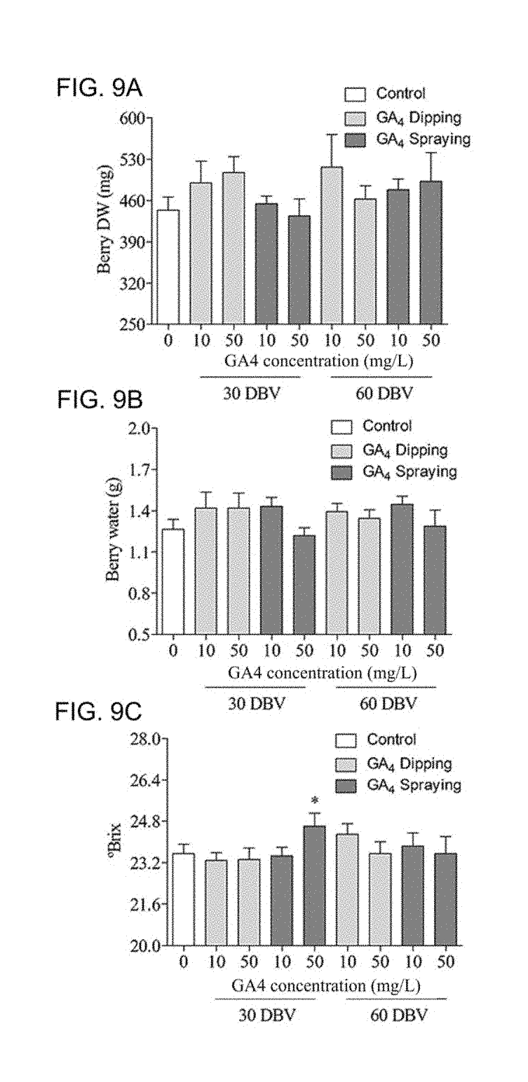

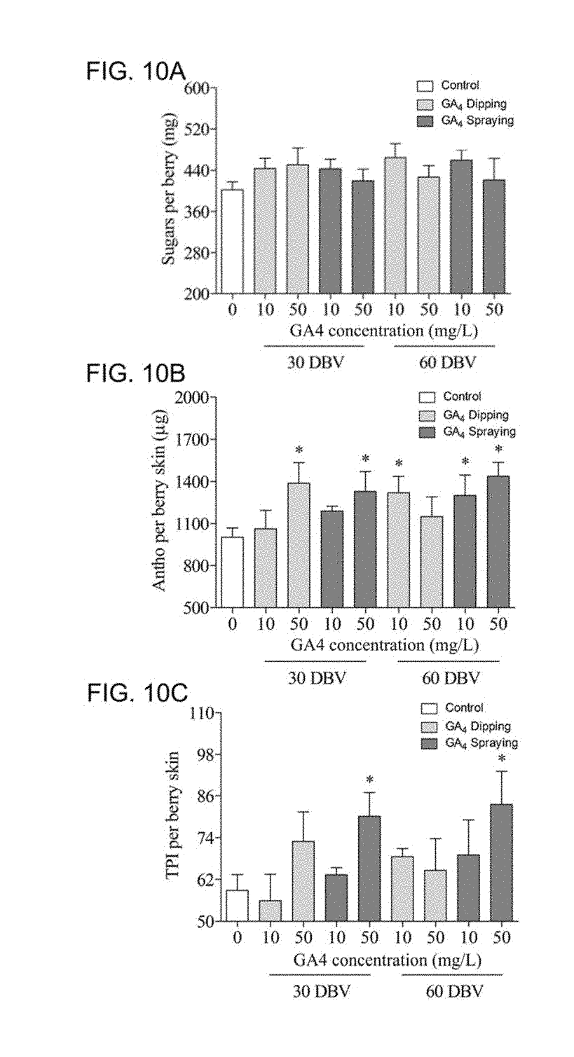

Both rates of GA4 applications (10 mg/L, 50 mg/L), and method of application, i.e. submersion and spraying at 60 DBV and at 30 DBV, increased the average bunch fresh weights and numbers of berries formed per bunch (FIGS. 8A, 8B), with harvest yield (average per bunch fresh weight) being significantly different from the controls in 5 out of 8 rates (FIG. 8A). Dry weights of individual berries also tended to be generally increased (FIG. 9A). The average per berry fresh weights, the per berry water content, and the °Brix for GA4 treatments were similar to the controls (FIGS. 8C, 9B), 9C). Both GA4 rate and application method tended to result in increased per berry sugar levels in the berries (FIG. 10A). Anthocyanin concentrations and the total polyphenol index (TPI) of the grape skins showed appreciable increases, with many being significantly greater than controls (FIGS. 10B, 10C).

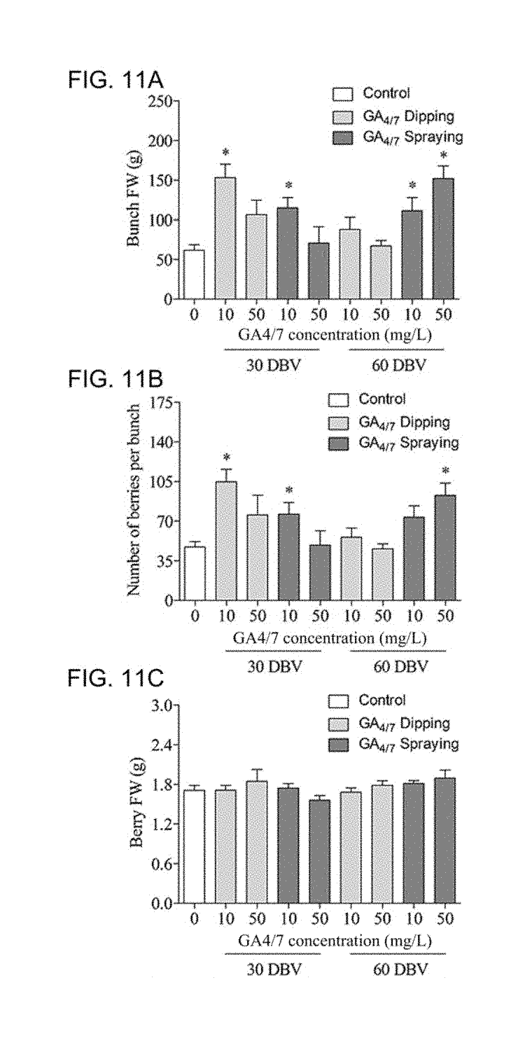

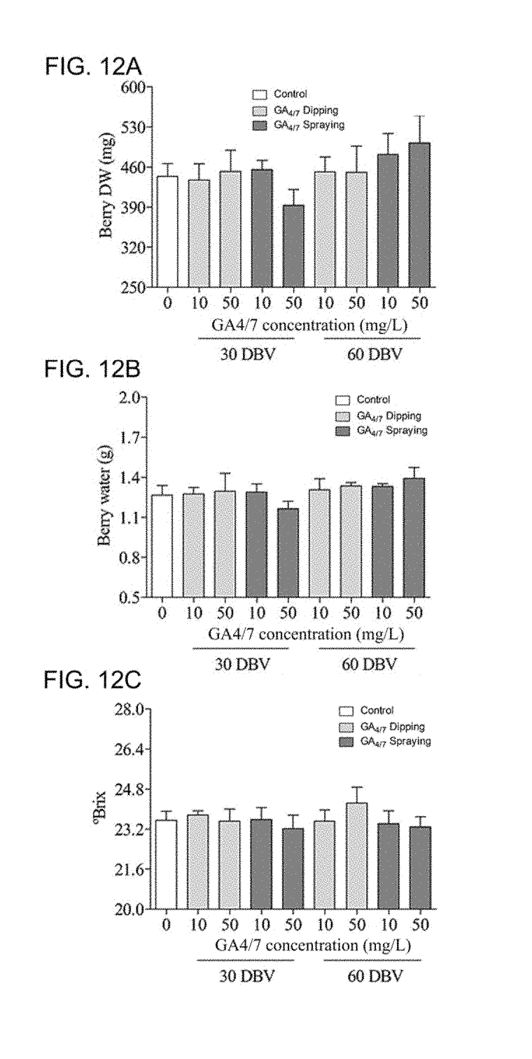

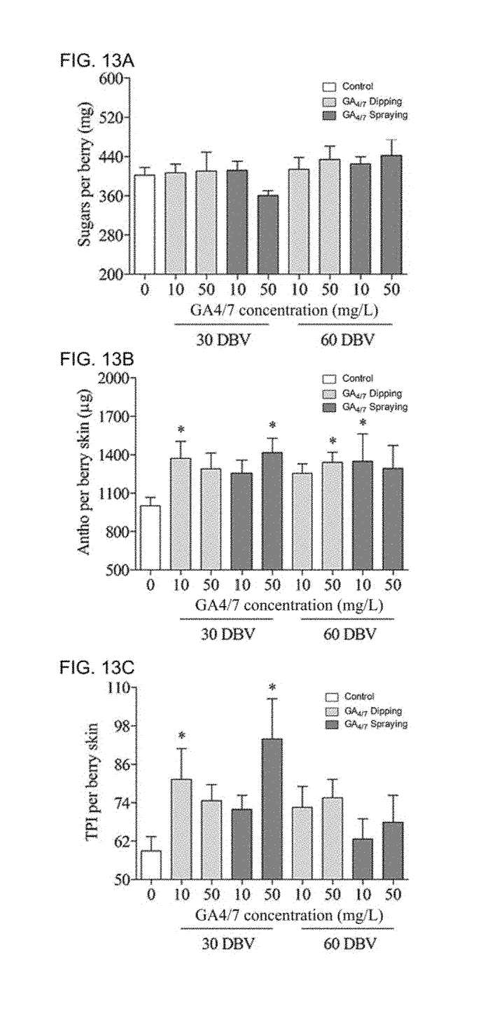

Both application rates of the GA4-rich GA4/7 mixture solutions (10 mg/L, 50 mg/L), and method of application, i.e., submersion and spraying at 60 DBV and at 30 DBV, increased the average per bunch fresh weights and the numbers of berries formed per bunch, with many of the increases showing significance, relative to the control (FIGS. 11A, 11B). The per berry fresh weights and dry weights, along with the water content, the °Brix, and sugar content were all similar to the control values (FIGS. 11C, 12A, 12B, 12C, 13A). However, both GA4/7 application rate and application method, i.e. submersion and spray, gave appreciably increased per berry skin anthocyanin concentration and total polyphenol index (TPI) (FIGS. 13B, 13C), with several of the increases being significantly different from the controls. Also, the 50 mg/L treatment of the GA4-rich GA4/7 mixture when applied at 60 DBV, increased the per berry dry weights relative to the controls (FIG. 12( ).

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference

What is claimed is:

1. A method for increasing the harvest yields of grapes, comprising:
application of a solution comprising one of GA5, GA4, or a mixture of GA4 and GA7 (GA4/7), to developing grape bunches.

2. The method according to claim 1, wherein the solution comprises an amount of GA5 selected from a range of 5 mg/L to 50 mg/L.

3. The method according to claim 1, wherein the solution comprises an amount of GA4 selected from a range of 5 mg/L to 50 mg/L.

4. The method according to claim 1, wherein the solution comprises an amount of a GA4/7 mixture selected from a range of 5 mg/L to 50 mg/L.

5. The method according to claim 1, wherein the GA5 or the GA4 or the GA4/7 is applied in the form of free acids or as salts or as esters.

6. The method according to claim 5, wherein the GA5 salts or the GA4 salts or the GA7 salts are sodium salts or potassium salts.

7. The method according to claim 5, wherein the GA5 esters or the GA4 esters or the GA4/7 esters are C₁₋₄ carboxyl acid esters.

8. The method according to claim 1, wherein the solution is applied during a period of time selected from a range of about 60 days before veraison to about 30 days before veraison.

9. The method according to claim 1, wherein the solution is applied about 60 days before veraison.

10. The method according to claim 1, wherein the solution is applied about 30 days before veraison.

11. The method according to claim 1, wherein a first application of the solution is made about 60 days before veraison and a second application of the solution is made about 30 days before veraison.

12. The method according to claim 11, wherein the first application of the solution is application of a GA5 solution and the second application is one of a G4 solution and a G4/7 solution.

13. The method according to claim 11, wherein the first application of the solution is one of a G4 solution and a G4/7 solution and the second application is application of a GA5 solution.
